(19) United States
(12) Patent Application Publication
(10) Pub. No.: US 2026/0034523 A1
(43) Pub. Date: Feb. 5, 2026

(54) STATIC MIXERS FOR USE WITH BIOPHARMACEUTICAL COMPOSITIONS AND METHODS FOR USING THE SAME

(71) Applicant: Sartorius Stedim FMT S.A.S., Aubagne Cedex (FR)

(72) Inventors: Michael Zumbrum, New Oxford, PA (US); William Kimmick, Mechanicsburg, PA (US)

(73) Assignee: Sartorius Stedim FMT S.A.S., Aubagne Cedex (FR)

(21) Appl. No.: 18/789,835

(22) Filed: Jul. 31, 2024

(51) Int. Cl. B01F 25/431; B01F 25/4314; B01F 35/00; B01F 101/22; B01F 101/44; B33Y 10/00; B33Y 80/00

(52) U.S. Cl. CPC B01F 25/4319; B01F 25/4314; B01F 25/431971; B01F 35/165; B33Y 10/00; B33Y 80/00; B01F 2101/22; B01F 2101/44; B01F 2215/0422

(57) ABSTRACT

A static mixer for use with biopharmaceutical compositions includes a shell and a core. The shell defines a flow channel therethrough. The shell is formed as a lattice structure that defines a plurality of voids in fluid communication with the flow channel. The core is disposed within the flow channel of the shell. The core is configured to mix a first fluid and a second fluid together as the first fluid and the second fluid flow through the flow channel. The first fluid or the second fluid is a biopharmaceutical composition.

### BACKGROUND

### 1. Technical Field

The present disclosure relates to fluid handling and, more specifically, to static mixers suitable for biopharmaceutical compositions.

### 2. Discussion of Related Art

During manufacture, storage, and distribution of biopharmaceutical compositions, the biopharmaceutical compositions generally are mixed with other compositions to improve shelf life. For example, a biopharmaceutical composition may be mixed with cryoprotectants to prevent damage to the biopharmaceutical composition during freezing for storage and transportation. For example, the biopharmaceutical compositions may be bulk mixed in a vat and portioned into long term storage containers and then frozen. Before use, the solution containing the biopharmaceutical composition is thawed and/or drained from the storage containers.

Static mixers have been used to mix two or more fluid together in-line while the fluids flow in a conduit. Generally, each fluid is contained in its own respective original container, the fluids flow contemporaneously through the conduit containing the static mixer which mixes the fluids into a substantially homogeneous solution. The solution is subsequently transferred into a storage container. The static mixer induces intense turbulence in the fluids to cause mixing.

Often, biopharmaceutical compositions are delicate and not amenable to turbulent mixing. For example, biopharmaceutical compositions may contain living cells that could be damaged or killed during turbulent mixing. Specifically, the shear stress experienced by fluids mixed with static mixers may exceed a level the biopharmaceutical composition can withstand without damage. As such, conventional static mixers are not suitable for use with biopharmaceutical composition.

### SUMMARY

This disclosure relates generally to static mixers for mixing biopharmaceutical compositions. Specifically, static mixers capable of mixing biopharmaceutical compositions without damaging the biopharmaceutical compositions.

In an aspect of the present disclosure, a static mixer for use with biopharmaceutical compositions includes a shell and a core. The shell defines a flow channel therethrough. The shell is formed as a lattice structure that defines a plurality of voids in fluid communication with the flow channel. The core is disposed within the flow channel of the shell. The core is configured to mix a first fluid and a second fluid together as the first fluid and the second fluid flow through the flow channel. The first fluid or the second fluid is a biopharmaceutical composition.

In aspects, the static mixer the static mixer is configured to mix the biopharmaceutical composition without damaging the biopharmaceutical composition. The core may be configured to thoroughly mix the first fluid and the second fluid. The static mixer may be configured to mix the first fluid and the second fluid without exceeding a predetermined shear stress within the biopharmaceutical composition.

In some aspects, the static mixer is configured to be inserted into a fluid passage defined by a couple through which the first fluid and the second fluid flow. The shell may be configured to frictionally engage the couple to fix the static mixer to the coupler. The static mixer may be of monolithic construction. The shell may be configured to minimize the amount of material used to form the static mixer.

In certain aspects, a fluid mixing kit includes the static mixer and a coupler. The coupler may define a fluid passage. The static mixer may be selectively insertable into the fluid passage of the coupler. The fluid mixing may include another static mixer. The fluid mixing kit may have a first configuration in which the static mixer is inserted into the coupler. The fluid mixing kit in first configuration may be configured to mix a first fluid and a second fluid. The fluid mixing kit may have a second configuration in which the static mixer and the other static mixer are inserted in the coupler. The fluid mixing kit in the second configuration may be configured to mix at least two fluids that are different from the first fluid and the second fluid.

In another aspect of the present disclosure, a static mixer for use with biopharmaceutical compositions includes a shell and a core. The shell defines a flow channel therethrough. The shell has a first end and a second end opposite the first end. The first end and the second end are spaced apart by a shell wall. The first end and the second end are in fluid communication with each other through the flow channel. The shell wall is formed as a lattice structure such that the shell wall defines a plurality of voids therethrough. The core is disposed within the shell. The core and the shell wall are configured to mix a biopharmaceutical composition during mixing.

In aspects, the shell includes a securement mechanism configured to fix the static mixer a coupler. The core may be configured to thoroughly mix the first fluid and the second fluid. The securement mechanism is a lip projecting outwardly from the first end or the second end of the shell.

In some aspects, the shell and the core form a mixer unit. The static mixer may include a first mixer unit having a first length and a second mixer unit having a second length. The second mixer unit may extend from the first mixer unit such that static mixer unit has a length equal to the first length plus the second length. The first mixer unit and the second mixer unit may be identical to one another. The static mixer may be of monolithic construction.

In certain embodiments, the plurality of voids are of various sizes and dimensions. An exterior surface of the shell wall is in fluid communication with the flow channel through the plurality of voids.

In particular embodiments, the core is a helical member extending along the flow channel. The helical member may include a single blade wrapped helically about a central axis of the core. The helical member may include two opposed blades. The core may have a skew in the range of 5-degrees to 75-degrees with respect to the transverse axis of the static mixer. The core may have a pitch in the range of 5-millimeters to 25 millimeters. The core may have a rake in the range of 5-degrees to 75-degrees with respect to the longitudinal axis of the static mixer.

In embodiments, the core is a baffle member including a first blade and a second blade. The first blade and the second blade may be angled with respect to each other in a range of 20 degrees to 120 degrees to define a flow gap therebetween. The core may be a grate member including a plurality of plurality of bars, each bar may be angled with respect to an adjunct bar in a range of 20 degrees to 120 degrees to define a flow gap there between.

In another aspect of the present disclosure, a method of mixing biopharmaceutical compositions includes inserting a static mixer into a coupler and flowing a first fluid and a second fluid through the static mixer. The first fluid and the second fluid are flowed through the static mixer such that the first fluid and the second fluid are mixed together while the shear stress experience by the first fluid and the second fluid during mixing remains below a predetermined shear stress.

In aspects, inserting the static mixer includes fixing the static mixer to the coupler. Inserting the static mixer may include inserting another static mixer into the coupler.

In another aspect of the present disclosure, a method of manufacturing a static mixer for mixing biopharmaceutical composition includes simulating flow through the static mixer, determining topology of the static mixer, and forming the static mixer. Simulating flow includes simulating flow of a first fluid and a second fluid through a coupler including a static mixer. Determining a topology of the static mixer includes determining a topology of the static mixer to mix the first fluid and the second fluid while limiting the shear stress for the first fluid and the second fluid below a predetermined shear stress. Forming the static mixer includes forming, by additive manufacturing, the static mixer with the determined topology.

In another aspect of the present disclosure, a static mixer for use with biopharmaceutical composition includes a core. The core has a first end and a second end opposite the first end. The core defines a first set of flow channels and a second set of flow channels. The first set of flow channels extend between the first end and the second end along a longitudinal axis of the core. The second set of flow channels extend transverse to the longitudinal axis of the core. The core is configured to mix a first fluid and a second fluid together as the first fluid and the second fluid flow through the first set of flow channels and the second flow channels. The first fluid or the second fluid being a biopharmaceutical composition.

In aspects, the core defines a third set of flow channels. The third set of flow channels may extend transverse to the longitudinal axis of the core. The second set of flow channels and the third set of flow channels may extend transvers to the longitudinal axis of the core perpendicular with respect to each other. The first set of flow channels, the second set of flow channels, and the third set of flow channels may intersect each other such that the core is formed as a lattice structure.

In some aspects, the first end has a has a first diameter and the second end has a second diameter. The core may have a taper along the longitudinal axis such that the first diameter is smaller than the second diameter. The first set of flow channels and the second set of flow channels may be defined to have a wavy flow path. The static mixer may be of mono lithic construction.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 is a perspective of a static mixer in accordance with embodiments of the present disclosure;

FIG. 2 is a top view of the static mixer of FIG. 1;

FIG. 3 is an endview of the static mixer of FIG. 1;

FIG. 4 is a perspective view of a static mixing kit provided in accordance with the present disclosure including a coupler and the static mixer of FIG. 1;

FIG. 5 is a perspective view of the kit of FIG. 4 with the static mixer inserted within a fluid passage of the coupler;

FIG. 6 is a side elevation view of the kit of FIG. 5 with a second static mixer inserted in the fluid passage of the coupler;

FIG. 7 is side elevation view of another static mixing kit provided in accordance with the present disclosure including a coupler and the static mixer of FIG. 1 partially inserted in a fluid passage of the coupler;

FIG. 8 is a side elevation view of another static mixing kit provided in accordance with the present disclosure including a coupler and the static mixer of FIG. 1 inserted in a fluid passage of the coupler;

FIG. 9 is a top elevation view of another static mixing kit provided in accordance with the present disclosure including the kits of FIGS. 4, 7, and 8;

FIG. 10 is a flowchart illustrating a method of manufacturing a static mixer in accordance with the present disclosure;

FIG. 11 is a flowchart illustrating a method of mixing biopharmaceutical compositions in accordance with the present disclosure;

FIG. 12 is a perspective view of an example static mixer in accordance with embodiments of the present disclosure;

FIG. 13 is a top view of the static mixer of FIG. 12;

FIG. 14 is an endview of the static mixer of FIG. 12;

FIG. 15 is a perspective view of another example static mixer in accordance with embodiments of the present disclosure;

FIG. 16 is a front view of the static mixer of FIG. 15;

FIG. 17 is an end view of the static mixer of FIG. 15;

FIG. 18 is perspective view of another example static mixer in accordance with embodiments of the present disclosure;

FIG. 19 is front view of the static mixer of FIG. 18;

FIG. 20 is an end view of the static mixer of FIG. 18;

FIG. 21A is a perspective view of another example static mixer in accordance with embodiments of the present disclosure;

FIG. 21B is another perspective of the static mixer of FIG. 21A;

FIG. 22A is a front view of the static mixer of FIG. 21A;

FIG. 22B is a front view of the static mixer of FIG. 21B;

FIG. 23A is an end view of the static mixer of FIG. 21A;

FIG. 23B is an end view of the static mixer of FIG. 21B;

FIG. 24A is a section view of the static mixer of FIG. 21 taken along section line 24-24 of FIGS. 21A and 23A;

FIG. 24B is a section view of the static mixer of FIG. 21B taken along section line 24-24 of FIGS. 21A and 23A;

FIG. 25A is a section view of the static mixer of FIG. 21A taken along section line 25-25 of FIG. 22A;

FIG. 25B is a section view of the static mixer of FIG. 21B taken along section line 25-25 of FIG. 22A;

FIG. 26A is a section view of the static mixer of FIG. 21A taken along section line 26-26 of FIG. 22A; and

FIG. 26B is a section view of the static mixer of FIG. 21B taken along section line 26-26 of FIG. 22A.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

As used herein the term “biopharmaceutical compositions” refers to a product coming from biotechnology, culture environments, cell cultures, buffer solutions, artificial nutrition liquids, blood products and derivatives of blood products, a pharmaceutical product, or more generally a product intended to be used in the medical field including, without any limitation, monoclonal antibodies (mAbs), therapeutic proteins, viruses, lipid nanoparticles, vaccines, virus banks, exosomes, cell banks, and cell therapy products. The term “thoroughly mixed” or “well mixed” refers to a substantially homogenous solution.

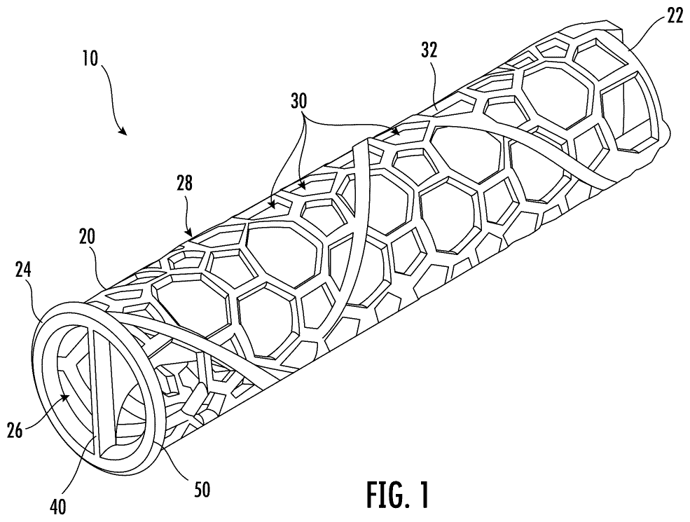

Referring now to FIGS. 1-3, a static mixer 10 in accordance with embodiments of the present disclosure is shown. The static mixer 10 may be configured to thoroughly mix a first fluid and a second fluid together into a substantially homogenous solution. In some embodiments, the static mixer 10 may be configured to mix a first fluid and a second flid to form an emulsion of the first fluid and the second fluid. The first fluid or the second fluid may be a biopharmaceutical composition. The other one of the first fluid or the second fluid may be, or include, at least one of the following cryoprotectants, nutrients, saline, alcohol, organic compounds (such as dimethyl sulfoxide (“DMSO”) or C₂H₆OS, media, cells, biological agents, tissue, agglomerates of cells, etc.), or other solutions. The static mixer 10 may mix the fluids without damaging the biopharmaceutical composition, e.g., without damaging any cells contained with the biopharmaceutical composition. The static mixer 10 may mix the first fluid and the second fluid such that the shear stress experienced by the fluids during mixing does not exceed a predetermined shear stress.

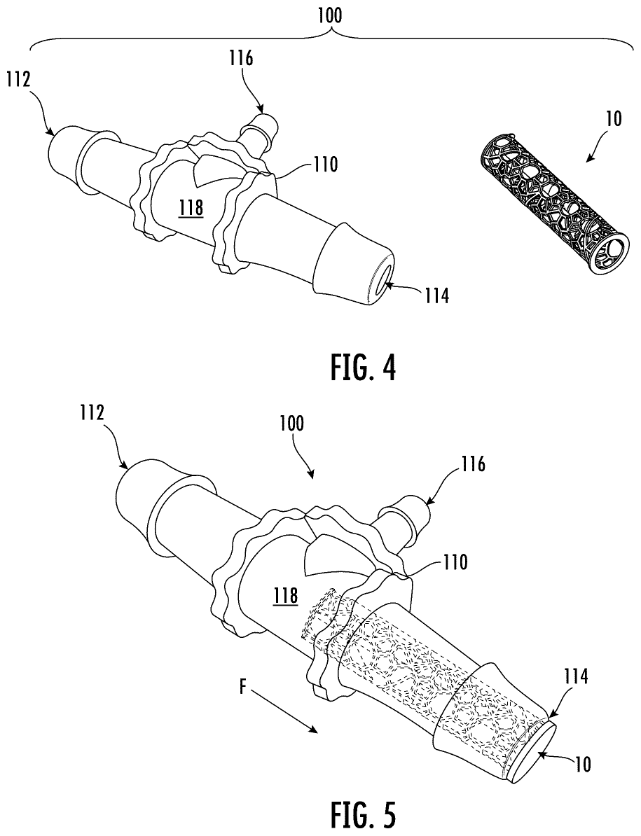

The static mixer 10 is insertable into a coupler 110 (FIGS. 4 and 5) to mix the first fluid and the second fluid as the fluids flow therethrough. In embodiments, the static mixer 10 may be provided with a coupler 110 to form a kit. The static mixer 10 includes a shell 20 and a core 40. The core 40 is configured to mix the fluids as the fluids flow through the static mixer 10. In some embodiments, the core 40 and the shell 20 may cooperate to thoroughly mix the fluids as the fluids flow through the static mixer 10. The static mixer 10 may induce turbulent flow in the fluids to encourage mixing.

The shell 20 has a first end or an inlet 22, a second end or an outlet 24. The shell 20 defines a flow channel 26 that extends between the inlet 22 and the outlet 24 through which the fluids flow during mixing. The inlet 22 and the outlet 24 are spaced apart by a shell wall 28.

The shell wall 28 is formed as a lattice structure that defines a plurality of voids 30. The lattice structure of the shell wall 28 may minimize an amount of material required to form the static mixer 10. In embodiments, an exterior surface 32 of the shell wall 28 is in fluid communication with the flow channel 26 through the voids 30. The lattice structure of the shell wall 28 may take any form suitable for positioning and supporting the core 40. In some embodiments, the lattice structure of the shell wall 28 may aid in mixing the first fluid and the second fluid. In embodiments, each void 30 may have the same size and dimension. The voids 30 may be circular or may be polygonal. For example, the voids 30 may be hexagonal such that the lattice structure has a honeycomb structure. In some embodiments, the voids 30 have various sizes and dimensions, as shown in FIG. 1. The voids 30 may be uniformly distributed along the length of the shell wall 28. In certain embodiments, the voids 30 may be distributed non-uniformly along the length of the shell 20. For example, the voids 30 may have higher density near the inlet 22 and a lower density near the outlet 24.

The shell 20 may have a cylindrical profile with the inlet 22 and the outlet 24 having equal diameters. In some embodiments, the shell 20 has a tapered profile with the diameter of the inlet 22 and the outlet 24 being different from each other. For example, the shell 20 may have a frustoconical profile with the inlet 22 having a diameter greater than the outlet 24 or vice versa. The diameter of the inlet 22 or the outlet 24 may be in the range of 1 millimeter to 25 millimeters. The static mixer 10 may be sized and dimensioned for a variety application. For example, the diameter of the static mixer 10 is in the range of a few nanometers to several centimeters. In embodiments, the diameter of the static mixer 10 may be in the range of 25 nm to 500 nm, e.g., 50 nm, 100 nm, 125 nm, 250 nm, or 450 nm. In certain embodiments, the diameter of the static mixer 10 may be in the range of 1 μm to 500 μm, e.g., 10 μm, 25 μm, 75 μm, 150 μm, 250 μm, or 450 μm. In embodiments, the diameter of the static mixer 10 may be in the range of 1 mm to 50 mm or more than 50 mm, e.g., 10 mm, 25 mm, or 35 mm. In particular embodiments, the diameter of the static mixer 10 may be in the range of 1 cm to 50 cm or more than 50 cm, e.g., 10 cm, 25 cm, or 35 cm. In some embodiments, the static mixer 10 has a polygonal cross-section such as rectangular, square, triangular, or octahedral.

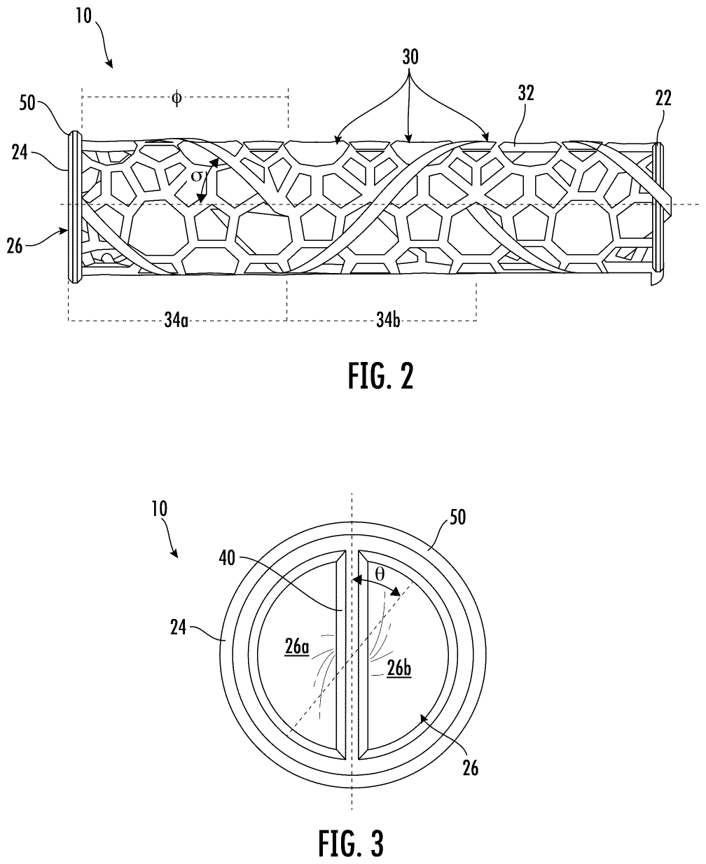

Continuing to refer to FIGS. 1-3, the core 40 of the static mixer 10 extends within the shell wall 28 such that the flow channel 26 is separated into discrete portions. As depicted, the core 40 is single member that divides the flow channel 26 into roughly two equal portions flow paths 26a, 26b. In some embodiments, the core 40 includes more than one arm such that the flow channel 26 is separated into more than two portions. For example, the core 40 may be a three-pointed star that divides the flow channel 26 into three portions. The core 40 may have a helical, propeller like shape with two opposed blades. The helix of the core 40 may define the flow paths 26a, 26b such that the fluids separate and converge as they flow therethrough. The core 40 may have a skew θ between 5-degrees and 75-degrees with respect to the transvers axis of the static mixer 10 (FIG. 3). The core 40 may have a rake σ between 5-degrees and 75-degrees from the longitudinal axis of the static mixer 10 (FIG. 2). The rake σ may be flat (straight) or curved (progressive). The core 40 may have a pitch φ, the distance between two adjacent point along the length of the core, in the range of 5 millimeters to 25 millimeters, e.g., 15 millimeters (FIG. 2). The size and dimension of the core 40 may be scaled with the diameter of the static mixer 10, as such, the core 40 may be sized and dimensioned in the range of a few nanometers to several centimeters as described above with respect to the diameter of the static mixer 10. The core 40 may be a solid member. In embodiments, the core 40 is formed as a lattice structure. In some embodiments, the core 40 includes several baffles projecting into the flow channel 26 from the interior wall of the shell 20. In particular embodiments, the core 40 is a network of intersecting crisscrossing blades.

With particular reference to FIG. 2, the static mixer 10 may be made up of several mixer units 34 formed of the shell 20 and the core 40. Forming the static mixer 10 from the mixer units 34 may allow for customizable or modular static mixers 10. An individual mixer unit 34 may represent the shortest length static mixer 10. In such an embodiment, the static mixer 10 includes only a single mixer unit 34. A longer static mixer 10 may be achieved by including two or more mixer units 34. Additional mixer units 34 may be included in the design of the static mixer 10 until the desired length and or performance of static mixer 10 is achieved. The length of the static mixer 10 may be between 10 millimeters and 100 millimeters, e.g., 40 millimeters. In particular embodiments, the length of the static mixer 10 may be in the range of a few microns to several millimeters. For example, the length of the static mixer 10 may between 10 μm and 500 μm or more than 500 μm, e.g., 10 μm, 25 μm, 75 μm, 150 μm, 250 μm, or 450 μm.

In some embodiments, the static mixer 10 includes a first mixer unit 34a and a second mixer unit 34b. The first mixer unit 34a may be identical to the second mixer unit 34b with the second mixer unit 34b extending from the first mixer unit 34a. The first mixer unit 34a and the second mixer unit 34b may be radially offset from one another, e.g., with the skew θ of the portion of the core 40 of the second mixer unit 34b offset 90-degrees from the skew θ of the portion of the core 40 of the first mixer unit 34a.

In certain embodiments, the first mixer unit 34a may be different from the second mixer unit 34b. Including different mixer units 34a, 34b in a static mixer 10 may create different flow characteristics within the static mixer 10. For example, the first mixer unit 34a may create more turbulent flow than the second mixer unit 34b or vice versa. In some embodiments, the first static mixer 10 may be made up of several of the first mixer unit 34a and the second mixer unit 34b in alternating positions with the each of the first mixer units 34a adjacent to one of the several second mixer units 34b on either side. In other embodiments, the static mixer 10 is made up of several of the first mixer unit 34a and the second mixer unit 34b with all of the first mixer units 34a disposed adjacent to each other and all of the second mixer units disposed adjacent to each other. For example, the first mixer units 34a may be disposed nearest the inlet 22 and the second mixer units 34b may be disposed nearest the outlet 24. In some embodiments, the shell 20 may hold the first mixer unit 34a and the second mixer unit 34b together to form a stable structure.

Referring to FIGS. 1-3, the static mixer 10 may include a securement mechanism 50 to fix the static mixer 10 in place within the coupler 110. The securement mechanism 50 may engage internal features of the coupler 110. As depicted, the securement mechanism 50 is a lip projecting outwardly from the inlet 22 or outlet 24 of the shell 20. In some embodiments, the lip may abut an end of the coupler 110. The coupler 110 may form a contiguous surface with the end of the coupler 110 when the static mixer 10 is received within the coupler 110. In certain embodiments, the lip may be received with a groove defined by the coupler 110. The securement mechanism 50 may engage the coupler 110 to prevent the static mixer 10 from being flushed downstream when fluid is flowed through the coupler 110. In some embodiments, the securement mechanism 50 includes a snap fitting that locks the static mixer 10 to the coupler 110. In certain embodiments, the securement mechanism 50 includes a crimp collar that may be plasticly deformed to secure the static mixer 10 to the coupler 110. The static mixer 10 may be frictionally engaged with the coupler 110 to fix the static mixer 10 within the coupler 110. The shell 20 may be engaged with an interior wall of the coupler 110 to frictionally engage the coupler 110. In certain embodiments, the shell wall 28 may be sized slightly larger than the interior wall of the coupler 110 such that when the shell 20 is disposed within the coupler 110, the shell wall 28 is slightly compressed and engaged with the interior wall of the coupler 110 to secure the shell 20 within the coupler 110.

When the static mixer 10 is inserted within the coupler 110, the shell 20 may position the core 40 with respect to the coupler 110. For example, the shell 20 may engage the coupler 110 such that the core is positioned in the center of a fluid passage 118 defined by the coupler 110. In some embodiments, the shell 20 is sized and dimensioned to be engaged with the interior wall of the coupler 110. In other embodiments, the shell 20 is sized and dimensioned to be spaced apart from the interior wall of the coupler 110. The static mixer 10 may thoroughly mix the fluids together between the inlet 22 and the outlet 24. For example, the first fluid and the second fluid may flow into the inlet 22 as substantially discrete or unmixed fluids and flow out of the outlet 24 as a substantially homogeneous solution. In embodiments, the static mixer 10 may prevent stagnation of flow at the boundary between the static mixer 10 and the interior wall of the coupler 110. In particular embodiments, the static mixer 10 may increase the rate of heat transfer between the first fluid and the second fluid as a result of the induced mixing. For example, where the first fluid flows into the inlet 22 at first temperature and the second fluid flows into the inlet 22 at a second temperature, the resulting solution may reach temperature equilibrium at the outlet 24. In some embodiments, the static mixer 10 may increase the rate of heat transfer across the coupler 110 to heat or cool the first fluid, the second fluid, or the solution as a result of the induced turbulent flow. In embodiments, other mixing elements may be included in the static mixer 10. For example, the static mixer 10 may include a filter element or dynamic mixing elements, e.g., impellers.

Referring to FIGS. 4-6, a static mixer kit 100 is provided in accordance with the present disclosure. The static mixer kit 100 includes the static mixer 10 and the coupler 110 that receives the static mixer 10 therein. The coupler 110 may be a connector, a tube, a pipe, or a conduit. The coupler 110 may be a commercially available coupler. The coupler 110 may be flexible or rigid. As used herein, the term “rigid” means an element that is devoid of flexibility. As shown, the coupler 110 is a T-coupler that defines a first opening 112, a second opening 114, and third opening 116. The coupler 110 defines a fluid passage 118 so that each opening 112, 114, 116 are in fluid communication with one another. The openings 112, 114, 116 may be the same diameter or each of the openings 112, 114, 116 may be different diameters. For example, as shown, the first opening 112 and the second opening 114 have the same diameter while the third opening 116 has a smaller diameter. The diameter of the openings 112, 114, and 116 may be used to control the flow rate, the pressure, or the velocity of the first fluid, the second fluid, or the resulting solution into or out of the fluid passage 118. The coupler 110 may include a barb fitting to receive tubing thereon.

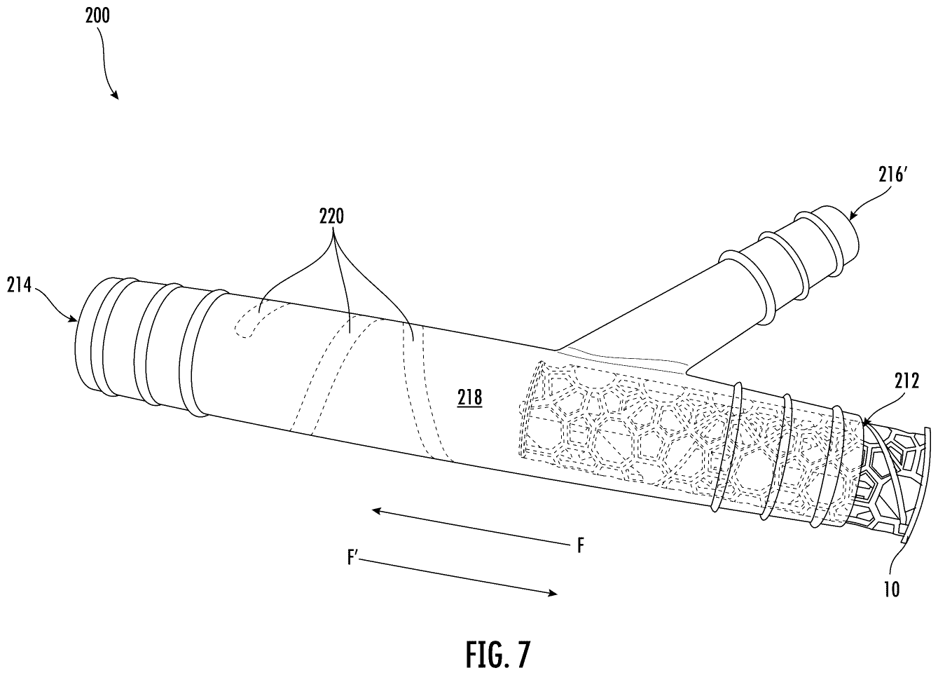

Referring to FIG. 7, another static mixer kit 200 provided in accordance with the present disclosure. The static mixer kit 200 includes a coupler 210 and a static mixer 10 that may be inserted into a fluid passage of the coupler 210. As shown, the coupler 210 is a Y-coupler that defines a first opening 212, a second opening 214, and third opening 216. The coupler 210 defines the fluid passage 218 so that each opening 212, 214, 216 are in fluid communication. The openings 212, 214, 216 may be the same diameter or each of the openings 212, 214, 216 may be different diameters. For example, as shown, the first opening 212 and the second opening 214 are the same diameter while the third opening 216 is a smaller diameter. A portion of the coupler 210 may include baffles 220 on an interior wall of the coupler 210 that extends into the fluid passage 218. The baffles 220 may provide for additional mixing of the fluids. When the baffles 220 are downstream of the static mixer 10 the baffles 220 may act as a secondary mixer.

Referring to FIG. 8, another static mixer kit 300 provided in accordance with the present disclosure. The static mixer kit 300 includes a coupler 310 and a static mixer 10 that may be inserted into a fluid passage 318 of the coupler 310. As shown, the coupler 310 is another Y-coupler that defines a first opening 312, a second opening 304, and third opening 316. The coupler 310 defines the fluid passage 318 so that each opening 312, 314, 316 are in fluid communication. The openings 312, 314, 316 may be the same diameter or each of the openings 312, 314, 316 may be different diameters. For example, as shown, the first opening 312 and the second opening 314 are the same diameter while the third opening 316 is a larger diameter.

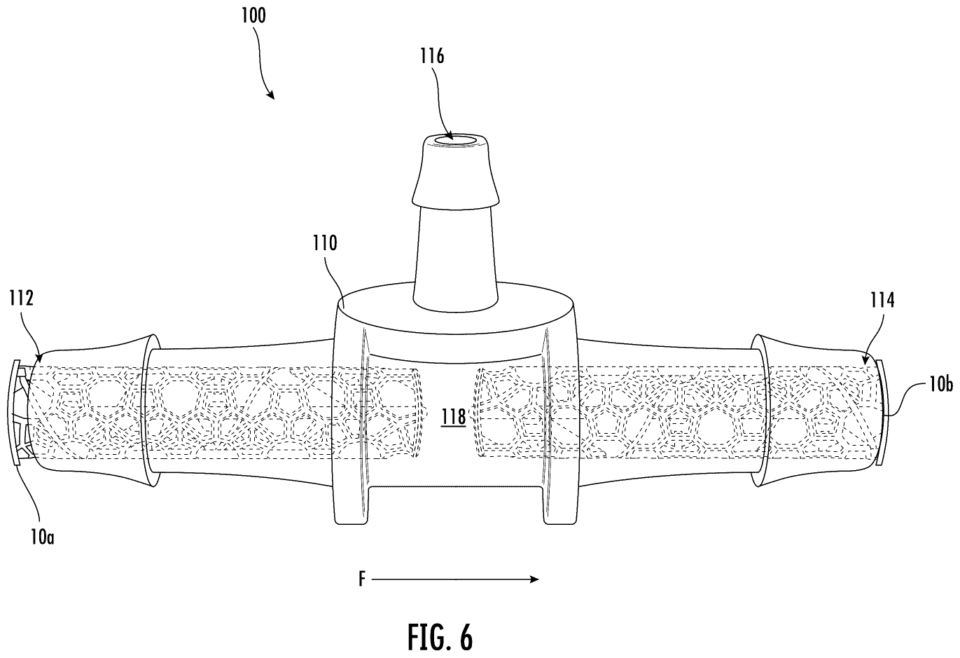

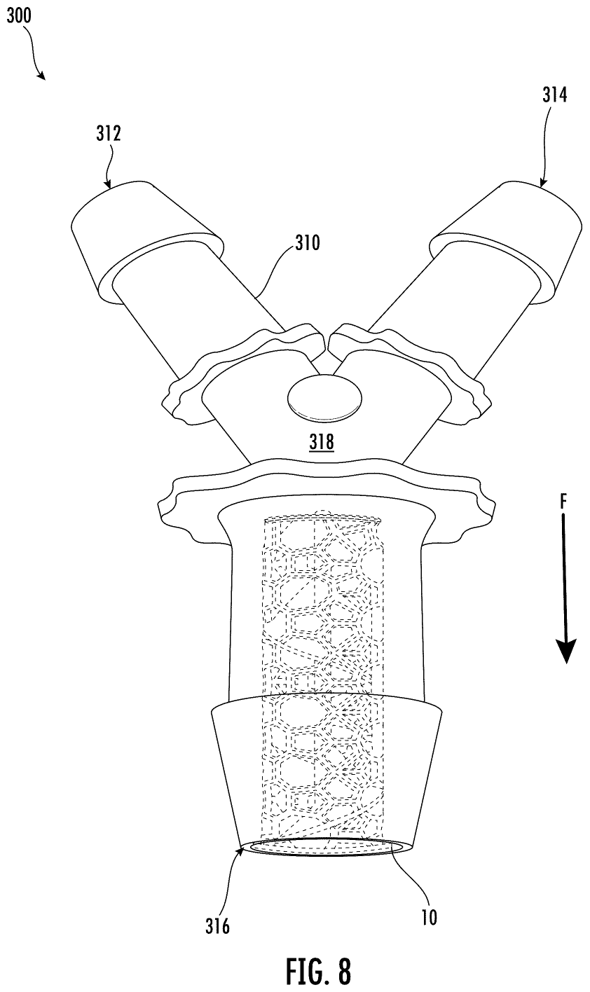

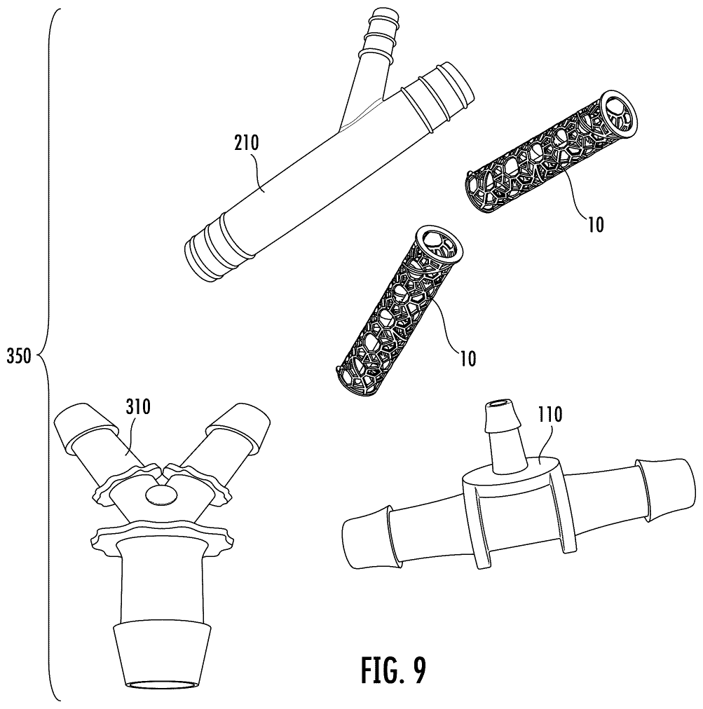

Referring to FIG. 9, a fluid mixing kit 350 may include one or more static mixers 10, the static mixer kit 100, the static mixer kit 200, and the static mixer kit 300. The fluid mixing kit 350 may be configured for a particular application. For example, the fluid mixing kit 350 may include static mixers 10 and couplers 110, 210, 310 configured specifically for mixing monoclonal antibodies (mAbs) with a cryoprotectant, e.g., glycerol (C₃H₈O₃) or sucrose (C₁₂H₂₂O₁₁). The fluid mixing kit 350 may be compatible with readily available laboratory equipment such as pumps, tubes, fittings, and containers. In certain embodiments, the fluid mixing kit 350 is configurable for several applications. For example, the fluid mixing kit 350 may have a first configuration for a first application and a second configuration for a second application. The first configuration may be the coupler 110 with a single static mixer 10 inserted therein as shown in FIG. 5. The second configuration may be the coupler 110 with two static mixers 10 inserted therein as shown in FIG. 6.

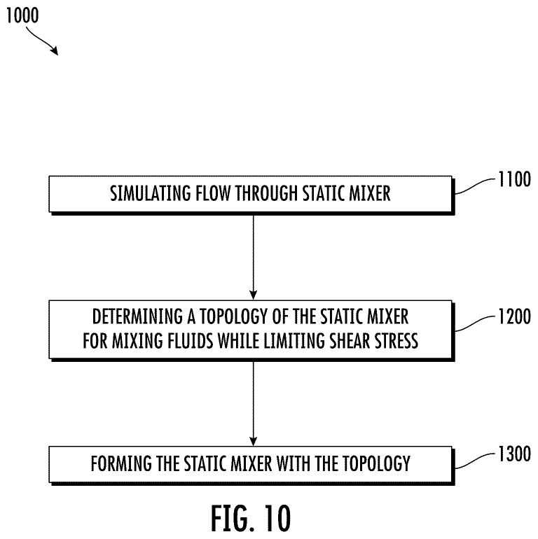

Referring to FIG. 10 a method 1000 of manufacturing a static mixer in accordance with embodiments of the present disclosure is described with reference to the static mixer 10 of FIGS. 1-3. The static mixer 10 is modeled and subjected to simulated flow having parameters matching the desired parameters of the application (Step 1100). The parameters may include volumetric flow rate, mass flow rate, pressure, viscosity, temperature, density, etc. In certain embodiments, computational fluid dynamics (CFD) models may be used to optimize the static mixer 10 for particular applications to achieve the desired amount of mixing.

The static mixer 10 may be iteratively modified to achieve a topology of the static mixer 10 with the desired performance (Step 1200). For example, the topology of the static mixer 10 may be optimized or adapted such that the shear stress experienced by the first fluid and the second fluid during mixing under the contemplated conditions does not exceed a predetermined shear stress. The static mixer 10 may mix the first fluid and the second fluid to form a homogeneous solution within its own length. In some embodiments, the static mixer 10 may be used to break down aggregates of cells, but not destroy the individual cells. In certain embodiments, the static mixer 10 may be used to create an emulsion be the first fluid and the second fluid.

Once the desired simulated performance and topology of the static mixer 10 is achieved in the model, the static mixer 10 may be manufactured through an additive manufacturing or rapid prototyping process, e.g., 3D printing (Step 1300). The additive manufacturing process may be, for example, Stereolithography (SLA), Selective Laser Sintering (SLS), Fused Deposition Modeling (FDM), Digital Light Process (DLP), Multi Jet Fusion (MJF), PolyJet, Direct Metal Laser Sintering (DMLS), or Electron Beam Melting (EBM). The lattice structure of the shell 20 may minimize or eliminate the need for support material during the manufacturing process and thus, may reduce material costs and post processing time. The entire static mixer 10 may be formed of monolithic construction. In certain embodiments, the lattice structure of the core 40 may aid in post processes of manufacturing the static mixer 10. For example, the lattice structure of the core 40 may assist in removal of residual liquid resin after additive manufacturing.

The static mixer 10 may be made from plastics such as acrylonitrile butadiene styrene (ABS), polylactic acid (PLA), polyethylene terephthalate glycol (PETG), nylon, or thermoplastic polyurethane (TPU). In some embodiments, the static mixer 10 is made of composites like carbon fiber, Kevlar®, or fiberglass. In certain embodiments, the static mixer 10 may be formed of a resin. In particular embodiments, the static mixer 10 is made of a metal such as titanium, aluminum, steel, or nickel alloy. The topology of the static mixer 10 may be tested with a prototype made a low cost, fast printing material such as ABS to confirm the performance of the static mixer 10. With the topology of the static mixer 10 finalized and the performance confirmed, a final material may be selected, e.g., steel or aluminum, for better durability. In some embodiments, the prototype material and the final material may be the same.

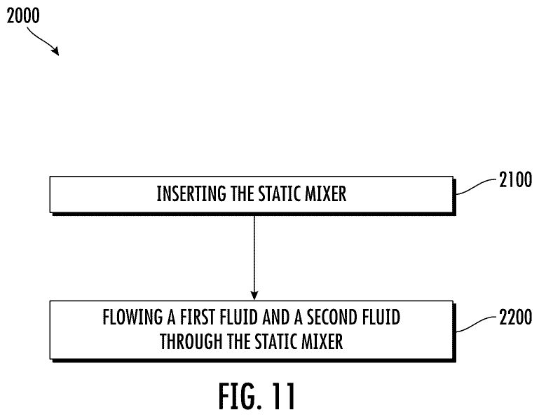

Referring to FIG. 11, a method 2000 of mixing biopharmaceutical compositions in accordance with embodiments of the present disclosure is described with reference to the static mixer 10 of FIGS. 1-3 and the static mixer kits 100, 200, 300 of FIGS. 4-8. The static mixer 10 is inserted into the fluid passage 118, 218, 318 of the coupler 110, 210, 310 (Step 2100). The static mixer 10 may be fixed to the coupler 110, 210, 310 with the securement mechanism 50. For example, the static mixer 10 may be pressed into the coupler 110, 210, 310 until the securement mechanism 50 engages the coupler 110, 210, 310 and fixes the static mixer 10 to the coupler 110, 210, 310. The securement mechanism 50 may prevent the static mixer 10 from being dislodged by the fluids flowing therethrough or by handling of the equipment. In some embodiments, the static mixer 10 is fixed to the coupler 110, 210, 310 without the securement mechanism 50. For example, the static mixer 10 may be fixed to the coupler 110, 210, 310 by friction between the interior walls of the coupler 110, 210, 310 defining the fluid passage 118, 218, 318 and the shell 20 of the static mixer 10.

In embodiments, more than one static mixer 10 may be inserted into the coupler 110, 210. The static mixers 10 may be inserted into the coupler 110 contiguously or may be spaced apart from one another. For example, as shown in FIG. 6, a first static mixer 10a and a second static mixer 10b may be inserted into the first opening 112 and the second opening 114, respectively, of the coupler 110. The first fluid may flow through the first static mixer 10a and the second fluid may flow into the coupler 110 between the first static mixer 10a and the second static mixer 10b. The first fluid and the second fluid may then flow through the second static mixer 10b and be thoroughly mixed together. Flowing the first fluid through the first static mixer 10a prior to flowing the second fluid into the coupler 110 may increase the rate of mixing of the first fluid and the second fluid. In some embodiments, flowing the first fluid through the first static mixer 10a prior to mixing the first fluid and the second fluid may allow for temperature adjustment of the first fluid prior to mixing with the second fluid. For example, the first fluid may be cooled or heated as it flows through the first static mixer 10a. The first fluid may be heated or cooled by an external source, or the first fluid is heated or cooled by the ambient air around the coupler 110. Heating or cooling the first fluid or the second fluid prior to mixing may prevent damage to a biopharmaceutical composition by thermal shock.

The first fluid and the second fluid may flow through the static mixer 10, and the coupler 110, 210, 310 to thoroughly mix the fluids together (Step 2200). As the first fluid and the second fluid flow through the coupler 110, 210, 310 and the static mixer 10 the fluids may be thoroughly mixed into a homogeneous solution within the length of the static mixer 10. The fluids are mixed such that any biopharmaceutical composition being mixed is not damaged. For example, the fluids may be mixed such that the neither the first fluid nor the second fluid experiences a shear stress above a predetermined shear stress. The predetermined shear stress may be determined by measuring viability of the biopharmaceutical composition through any methods or processes known in the art. For example, when flowing living cells through the static mixer 10 the viability of the cells may be measured to determine the necessary amount of shear to mix the fluid containing the cells without breaking the cell wall or causing cell lysis or cell death. When mixing of inanimate media, e.g., water and powder mixtures, the predetermined shear stress may be a less critical factor in the design of the static mixer 10. The resulting solution may be transferred to storage container and prepared for storage, transportation, or use.

With particular reference to FIGS. 11 and 5, in embodiments, both of the first fluid and the second fluid may flow into the coupler 110 upstream of the static mixer 10, with the arrow F indicating the direction of flow. The static mixer 10 may be inserted into the fluid passage 118 of the coupler 110 through the second opening 114. The first fluid may flow through the first opening 112 and the second fluid may flow through the third opening 116. The first fluid and the second fluid may flow through the fluid passage 118 of the coupler 110, enter the static mixer 10, and flow out of the second opening 114. Once the first fluid and the second fluid enter the static mixer 10 the fluids may be thoroughly mixed. Within the fluid passage 118 and prior to entering the static mixer 10, the first fluid and the second fluid may not substantially mix with each other.

Referring to FIGS. 11 and 7, in embodiments, the first fluid flows into the coupler 210 through the first opening 212 and the second fluid flows into coupler 210 through the third opening 216, with the arrow F indicating the direction of flow. The static mixer 10 may be inserted into the fluid passage 218 of the coupler 210 through the first opening 212 so that the first fluid flows into the fluid passage 218 and the flow channel 26 of static mixer 10 contemporaneously through the inlet 22. The static mixer 10 may extend into the coupler 210 such that as the second fluid is flowed into the coupler 210 the second fluid enters the flow channel 26 through the voids 30 and mixes with the first fluid. In some embodiments, the first fluid flows into the fluid passage 218 of the coupler 210 thorough the second opening 214 and the second fluid flows into the fluid passage 218 through the third opening 216, with the arrow F′ indicating the direction of flow. The first fluid and the second fluid mix within the static mixer 10 and flow out the first opening 212. In such embodiments, the first fluid and the second fluid enter the fluid passage 218 with different flow directions which may increase the rate of mixing of the fluids. For example, the different flow directions may create back flow or eddy currents within the fluid passage 218.

With reference to FIG. 8, the first fluid may flow into the fluid passage 318 of the coupler 310 through the first opening 312 and the second fluid may flow into the fluid passage 318 in through the second opening 314. The static mixer 10 may inserted into the fluid passage 318 through the third opening 316. The first fluid and the second fluid may flow contemporaneously through the static mixer 10 and out the third opening 316, with arrow F indicating the direction of flow. In some embodiments, a static mixer 10 is inserted into the fluid passage 318 through each of the opening 312, 314, 316 such that the coupler 310 has three static mixers 10 inserted therein.

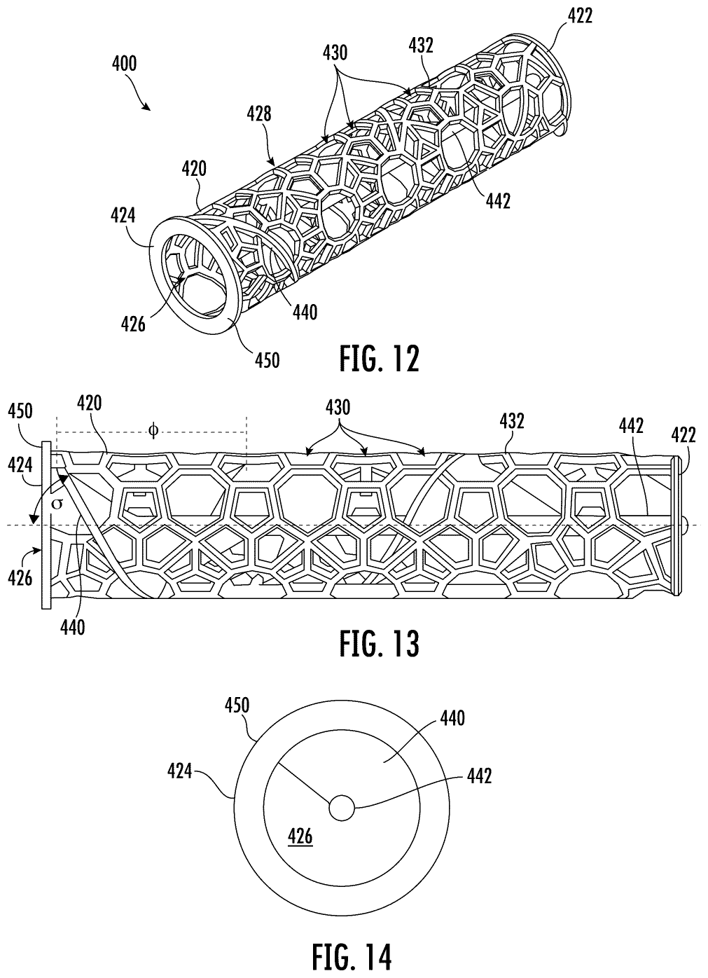

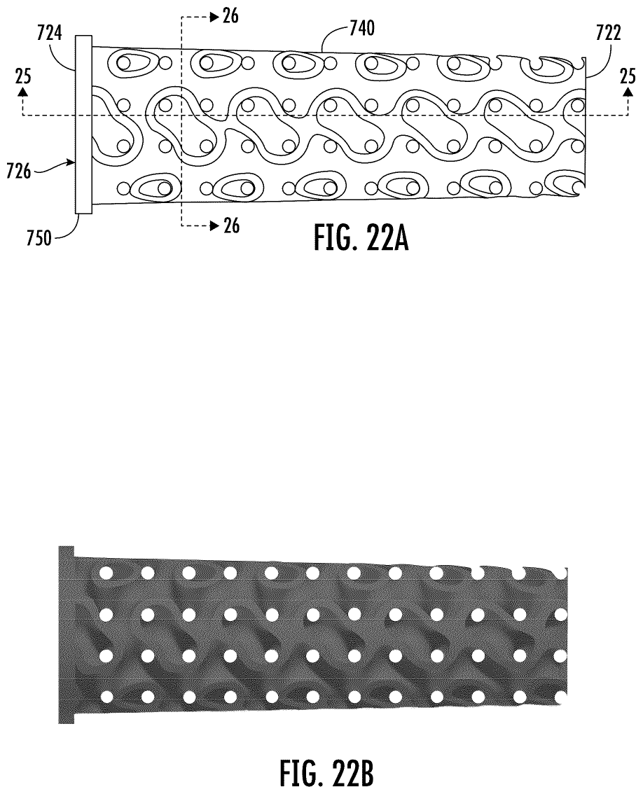

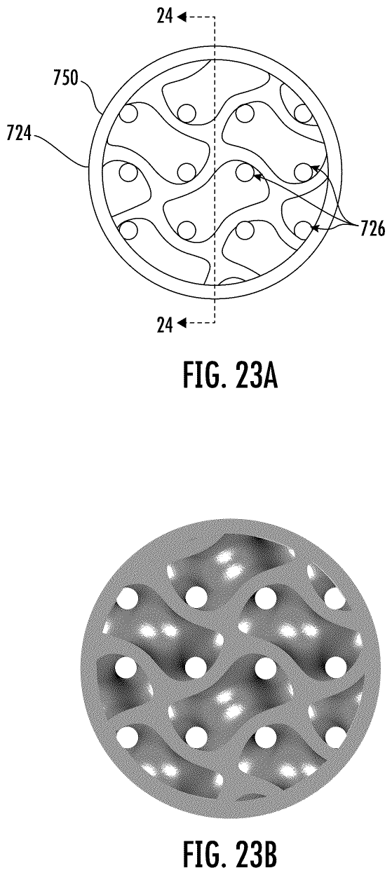

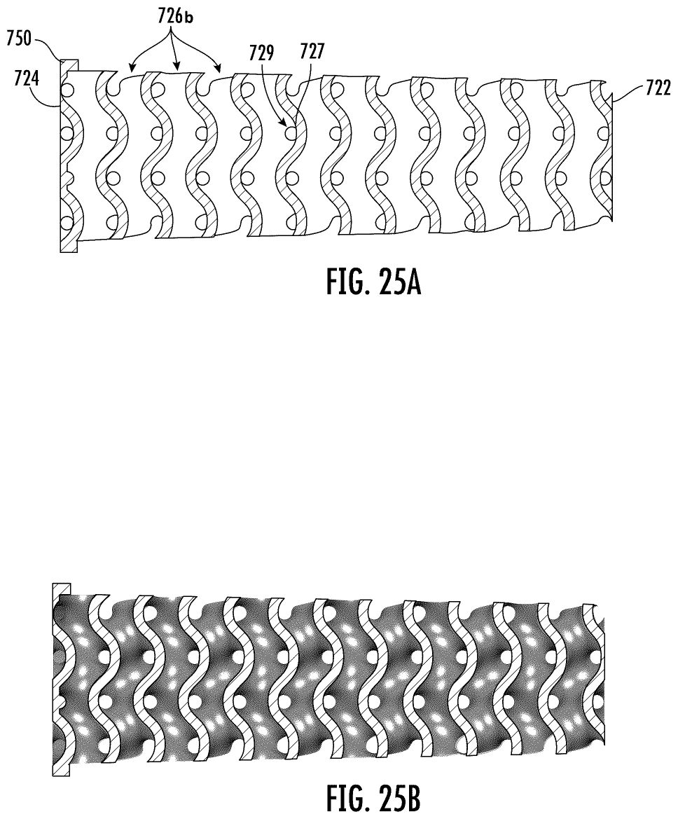

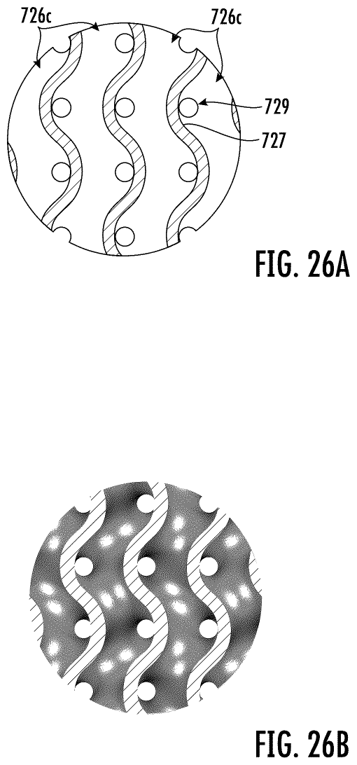

Generally referring now to FIGS. 12 to 26B, several example static mixers 400, 500, 600, 700 in accordance with the present disclosure are shown and described. The example static mixers 400, 500, 600, 700 described hereinbelow are similar to the static mixer 10 with similar elements labeled with a like number including a leading “4”, “5”, “6”, or “7”, respectively. For brevity, the static mixers 400, 500, 600, 700 are described with only the differences and distinguishing characteristics from the static mixer 10 described in detail. Primarily, the static mixers 10, 400, 500, 600, and 700 differ with respect to their respective cores 40, 440, 540, 640, and 740. Further, it should be appreciated that the example static mixers 400, 500, 600, 700 are not intended, and should not be interpreted, as limiting embodiments.

Referring to FIGS. 12 to 14, an example static mixer 400 is shown. The static mixer 400 includes a shell 420 and a core 440. The core 440 is a formed as a lattice structure that defines a flow channel 426. The core 440 extends within the shell 420 between an inlet 422 and an outlet 424 of the static mixer 400. The core 440 is formed as a corkscrew or a helical member wrapped about a central axis 442 that extends parallel to the central longitudinal axis of the static mixer 400. The core 440 may be considered a single blade helical member core 440, in comparison to the double blade helical member core 40 described above. The central axis 442 may be colinear with the central longitudinal axis of the static mixer 400. The core 440 have may have a rake σ between 5-degrees and 75-degrees from the longitudinal axis of the static mixer 400 (FIG. 13). The rake σ may be flat (straight) or curved (progressive). The core 440 may have a pitch φ, the distance between two adjacent points along the length of the core 440, in the range of 5 millimeters to 25 millimeters, e.g., 15 millimeters. Like the static mixer 10, the static mixer 400 includes a securement mechanism 450.

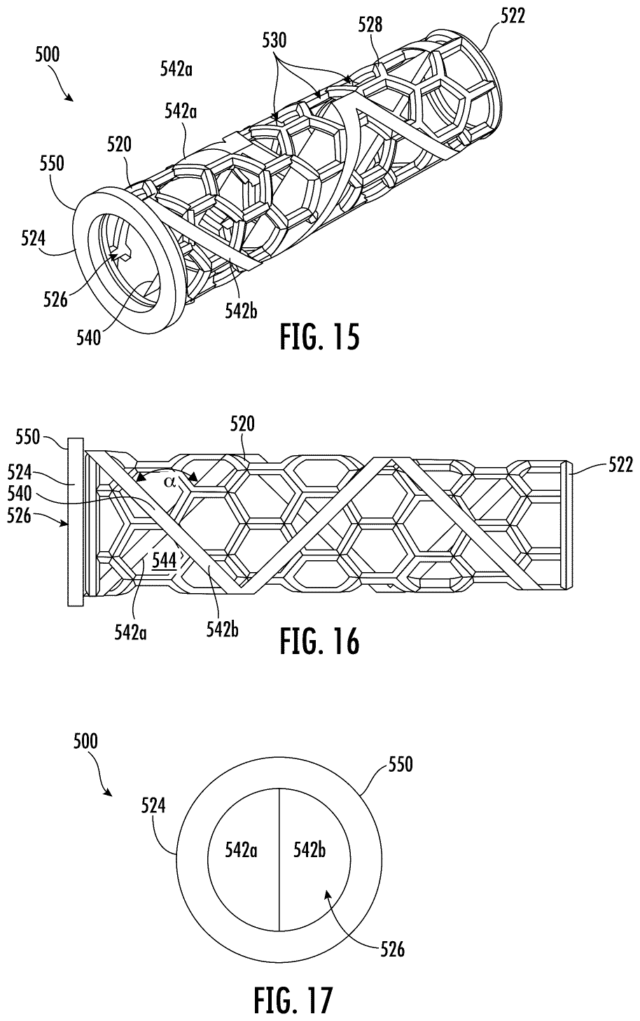

Referring to FIGS. 15-17, an example static mixer 500 is shown. The static mixer 500 includes a shell 520 and a core 540. The shell 520 is a formed as a lattice structure that defines a flow channel 526. The core 540 extends within the shell 520 between an inlet 522 and an outlet 524 of the static mixer 500. The core 540 is formed as baffle 542. The core 540 may include a plurality of baffles 542 spaced apart along the length of the static mixer 500. The baffle 542 includes a first blade 542a and second blade 542b that are angled with respect to each other at a blade angle α. The blade angle α may be between 120 degrees and 20 degrees. Angling the first blade 542a and the second blade 524b with respect to each other defines a flow gap 544 therebetween to allow the first fluid and the second fluid to flow through the flow channel 526 and mix. Increasing or decreasing the blade angle α may increase or decrease the shear stress experienced by the first fluid or the second fluid and, thus, the rate of mixing. The first blade 542a and the second blade 542b extend from opposing sections of a shell wall 528 of the shell 520 into the flow channel 526. As depicted, the first blade 542a and the second blade 542b extend from the shell wall 528 to the center of the flow channel 526. In embodiments including more than one baffle 542, each baffle 542 of the static mixer 500 may have the same baffle angle α or may have different blade angles α. For example, the baffle 542 nearest the inlet 522 may have a blade angle α of 90 degrees and the baffle 542 nearest outlet 524 may have a blade angel α of 45 degrees.

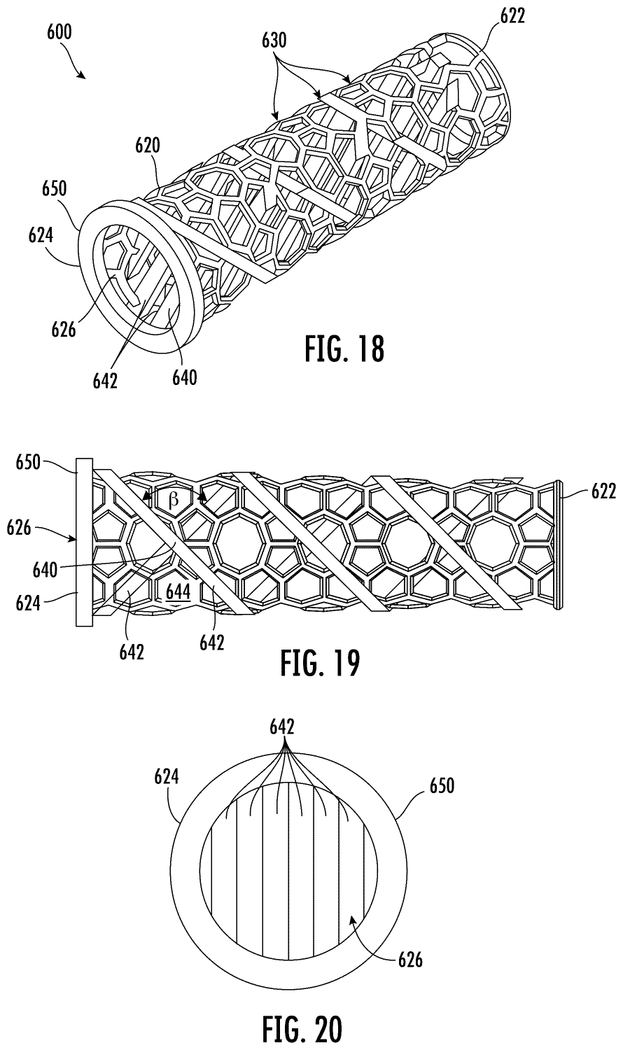

Referring to FIGS. 18-20, a static mixer 600 is shown. The static mixer 600 includes a shell 620 and a core 640. The shell 620 is a formed as a lattice structure that defines a flow channel 626. The core 640 extends within the shell 620 between an inlet 622 and an outlet 624 of the static mixer 600. The core 640 is formed as a grate. The core 640 may include more than one grate. In such embodiments, the gates of the core 640 may be spaced apart along the length of the static mixer 600. The core includes a plurality of bars 642 extending across the flow channel 626. Each bar 642 is angled with respect to the adjacent bars 642 at bar angle β. The bar angle β may be between 120 and 20 degrees. Angling the bars 642 with respect to each other defines a flow gap 644 therebetween to allow the first fluid and the second fluid to flow through the flow channel 626 and mix. Increasing or decreasing the bar angle β may increase or decrease the shear stress experienced by the first fluid or the second fluid and, thus, the rate of mixing. In embodiments including more than one grate in the core 640, each grate of the static mixer 600 may have the same bar angle β or may have different bar angles β. For example, the grate of the core 640 nearest the inlet 622 may have a bar angle β of 90 degrees and the grate nearest outlet 624 may have a baffle angel β of 45 degrees.

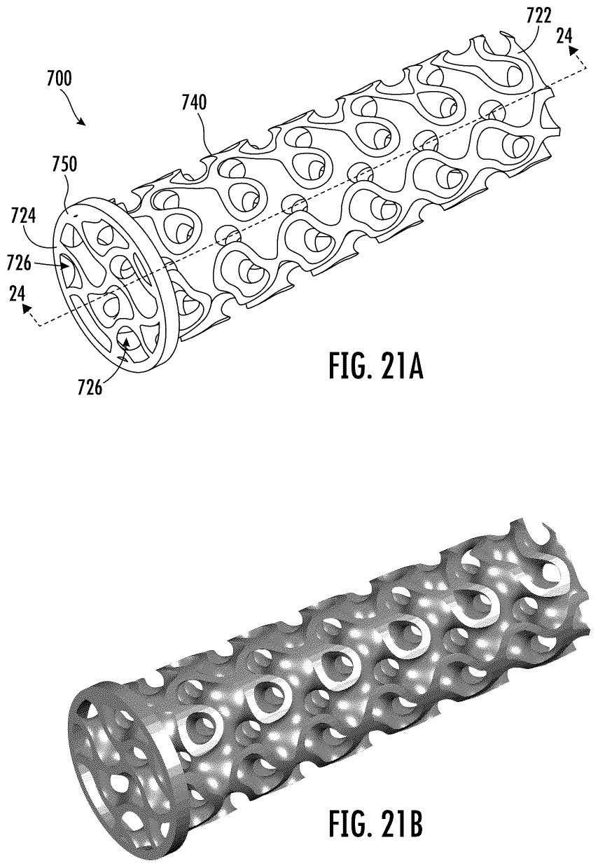

Referring to FIGS. 21A-23B, a static mixer 700 is shown. The static mixer 700 may be formed without a shell. In such embodiments, the core 740 itself may engage the interior wall of the coupler 110, 210, 310. Engagement of the core 740 with the coupler 110, 210, 310 may secure the static mixer 700 thereto. The core 740 includes an inlet 722 and an outlet 724. The core 740 defines a plurality of flow channels 726 that intersect with one another to such that the core 740 is formed as a lattice structure and the inlet 722 and the outlet 724 are in fluid communication through the flow channels 726. The intersecting network of flow channels 726 may mix a first fluid and second fluid as the fluids flow through the static mixer 700. The core 740 may taper from the inlet 722 to the outlet 724 such that the diameter of the core 740 at the inlet 722 is larger than the diameter of the core 740 at the outlet 724. The core 740 may taper in a range between 1 degree and 5 degrees from the longitudinal axis 24-24 of the body 710. In some embodiments, the core 740 tapers such that the diameter of the core 740 at the inlet 722 is smaller than the diameter of the core 740 at the outlet 724. The core 740 may be tapered along its entire length or may be tapered along a portion of its length. For example, the core 740 may have a uniform diameter from outlet 724 to the midpoint of the core 740 and may be tapered from the midpoint to the inlet 722. The taper of the core 740 may assist in insertion of the static mixer 700 into the conduit 110, 210, 310 or removal from the conduit 110, 210, 310. In embodiments, the taper of the core 740 may encourage mixing of the first fluid and the second fluid. For example, the taper of core 740 may alter the pressure head through the static mixer 700 such as through head loss as a result of the change in diameter of the core 740.

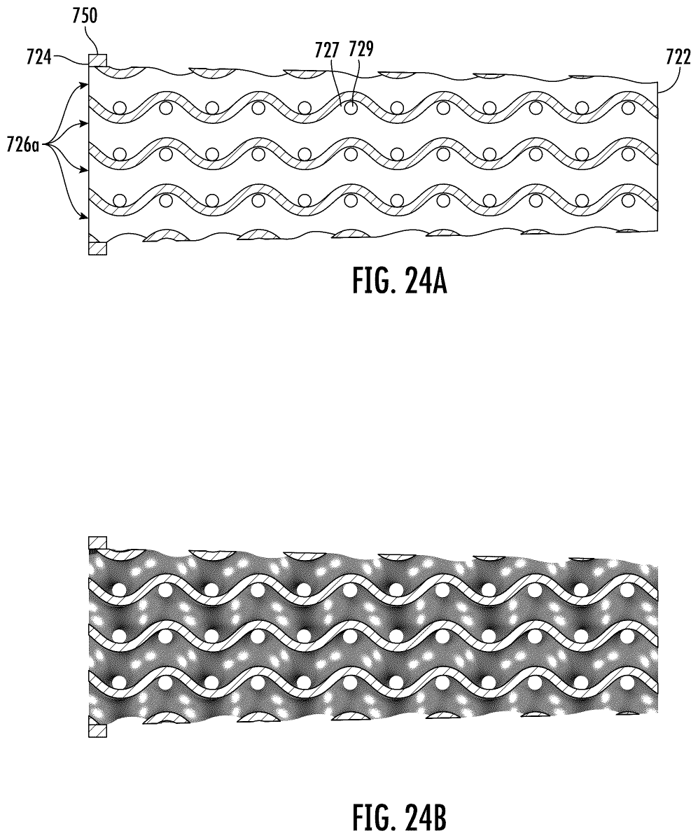

With particular reference to FIGS. 24A-26B, the flow channels 726 are defined along the longitudinal axis 24-24 and two transverse axes 25-25 and 26-26 of the static mixer 700. The flow channels 726 defined along the longitudinal axis 24-24 extend the length of the static mixer 700 between the inlet 722 and the outlet 724. The flow channels 726 extending along the longitudinal axis 24-24 may be considered a first set of flow channels 726a. Each flow channel 726a of first set of flow channels 726a may be parallel to each other. The flow channels 726 extending along the two transverse axes 25-25 and 26-26 may be considered a second set of flow channels 726b and a third set of flow channels 726c. Each flow channel 726b of the second set of flow channels 726b may be parallel to each other. Each flow channel 726b of the second set of flow channels 726c may be parallel to each other. The second set of flow channels 726b and the third set of flow channels 726c may be perpendicular with respect to each other. In some embodiments, flow channels 726a, 726b defined along the two transverse axes 25-25 and 26-26 of the static mixer 700 may be less than perpendicular to each other. The flow channels 726a, 726 may be perpendicular to the flow channels 726a. Each of the flow channels 726 may be defined to have a curved flow path. For example, as shown, each flow channel 726 is defined to have a wavy flow path. The curved flow path of the flow channels 726 may encourage mixing of the first fluid and the second fluid. Each flow channel 712 may be defined to avoid obstructing flow through adjacent flow channels 726. For example, as best shown in the cross-sectional views of FIGS. 24A-26B, the flow channels 726 may be defined to have a wavy flow path such that each flow channel 726 has several troughs 727. Each trough 727 may align with an opening 729 of one or more intersecting flow channels 726 such that the walls of the core 740 defining each flow channel 726 avoids obstructing an opening 729. In embodiments, the flow channels 726 may be defined to be straight or cylindrical. The flow channels 726 may have a uniform diameter or non-uniform diameter. For example, the diameter of the flow channels 726a may be larger at the inlet 722 than at the outlet 724. The plurality of flow channels 726 may be defined to have the same flow path. For example, the flow channels 726a, 726b, 726c may all have a wavy flow path as shown in FIGS. 24A-26B. In some embodiments, the plurality of flow channels 726 may be defined to have different flow paths. For example, the flow channels 726a may have a wavy flow path and the flow channels 726b, 726c may have straight flow paths. The taper of the core 740 may alter some of the flow channels 726. For example, as the core 740 tapers the flow channels 726 at the periphery of the core 740 may connect to adjacent flow channels 726 near the outlet 724. As the first fluid and the second fluid flow through the static mixer 700 the fluids may follow a tortuous path. For example, portions of the fluid may not flow directly through a single flow channel 726. Portions of the fluid may enter a flow channel 726a and may exit a flow channel 726b or 726c. The tortuous path the fluid may follow as a result of the interconnection of the plurality of flow channel 726 may encourage mixing of the first fluid and the second fluid.

The flow channels 726 positioned at the perimeter of the core 740 may be open along the length of the core 740. When the static mixer 700 is inserted within a coupler 110, 210, 310, the core 740 may cooperate with an interior wall of the coupler 110, 210, 310 such that engagement therebetween encloses the flow channels 726 at the perimeter of the core 740. Where the core 740 is tapered between the inlet 722 and the outlet 724, a portion of the core 740 may separate from the interior wall of the conduit 110, 210, 310 as the diameter of the core 740 decreases. In such embodiments, the flow channels 726 at the perimeter of the core 740 may be partially enclosed and partially open. For example, along the portion of the core 740 that engages the conduit 110, 210, 310, the flow channels 726 at the perimeter of the core 740 are enclosed by cooperation between the core 740 and the interior wall of the conduit 110, 210, 310 and along the portion of the core 740 that tapers and separates from the interior wall of coupler 110, 210, 310 the flow channels 726 are open.

The static mixer 700 may include a securement mechanism 750 to fix the static mixer 10 in place within the coupler 110, 210, 310. The securement mechanism 750 may engage internal features of the coupler 110, 210, 310. As depicted, the securement mechanism 750 is a lip projecting outwardly from the inlet 722 or outlet 724 of the core 740. Otherwise, the securement mechanism 750 may be any of the securement mechanisms described above with respect to the static mixer 10.

Although the method steps are described in a specific order, it should be understood that other steps may be performed in between described steps, described steps may be adjusted so that they occur at slightly different times, or the described steps may occur in any order unless otherwise specified.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A static mixer for use with biopharmaceutical compositions, the static mixer comprising:
a shell defining a flow channel therethrough, the shell formed as a lattice structure that defines a plurality of voids in fluid communication with the flow channel; and
a core disposed within the flow channel of the shell, the core configured to mix a first fluid and a second fluid together as the first fluid and the second fluid flow through the flow channel, the first fluid or the second fluid being a biopharmaceutical composition.

2. The static mixer according to claim 1, wherein the static mixer is configured to mix the biopharmaceutical composition without damaging the biopharmaceutical composition.

3. The static mixer according to claim 1, wherein the core is configured to thoroughly mix the first fluid and the second fluid.

4. The static mixer according to claim 1, wherein the static mixer is configured to mix the first fluid and the second fluid without exceeding a predetermined shear stress within the biopharmaceutical composition.

5. The static mixer according to claim 1, wherein the static mixer is configured to be inserted into a fluid passage defined by a coupler through which the first fluid and the second fluid flow.

6. The static mixer according to claim 4, wherein the shell is configured to frictionally engage the coupler to fix the static mixer to the coupler.

7. The static mixer according to claim 1, wherein the static mixer is of monolithic construction.

8. The static mixer according to claim 1, wherein the shell is configured to minimize the amount of material used to form the static mixer.

9. A fluid mixing kit comprising:
a static mixer according to claim 1; and
a coupler defining a fluid passage, the static mixer selectively insertable into the fluid passage of the coupler.

10. The fluid mixing kit according to claim 9, further comprising another static mixer according to claim 1.

11. The fluid mixing kit according to claim 10, wherein the fluid mixing kit has a first configuration in which the static mixer is inserted into the coupler, the fluid mixing kit in the first configuration configured to mix a first fluid and a second fluid.

12. The fluid mixing kit according to claim 11, wherein the fluid mixing kit has second configuration in which the static mixer and the other static mixer are inserted in the coupler, the fluid mixing kit in the second configuration configured to mix at least two fluids that are different from the first fluid and the second fluid.

13. A static mixer for use with biopharmaceutical compositions, the static mixer comprising:
a shell defining a flow channel therethrough, the shell having a first end and second end opposite the first end, the first end and the second end spaced apart by a shell wall, the first end and the second end in fluid communication with each other through the flow channel, the shell wall formed as a lattice structure such that the shell wall defines a plurality of voids therethrough; and
a core disposed within the shell, the core and the shell wall configured to mix a biopharmaceutical composition with another composition and prevent damage to the biopharmaceutical composition during mixing.

14. The static mixer according to claim 13, wherein the shell includes a securement mechanism configured to fix the static mixer to a coupler.

15. The static mixer according to claim 12, wherein the core is configured to thoroughly mix the first fluid and the second fluid.

16. The static mixer according to claim 14, wherein the securement mechanism is a lip projecting outwardly from the first end or the second end of the shell.

17. The static mixer according to claim 13, wherein the shell and the core form a mixer unit, the static mixer comprising a first mixer unit having a first length and a second mixer unit having a second length, the second mixer unit extending from the first mixer unit such that the static mixer has a length equal to the first length plus the second length.

18. The static mixer according to claim 17, wherein the first mixer unit and the second mixer unit are identical to one another.

19. The static mixer according to claim 17, wherein the static mixer is of monolithic construction.

20. The static mixer according to claim 13, wherein the plurality of voids are of various sizes and dimensions.

21. The static mixer according to claim 13, wherein an exterior surface of the shell wall is in fluid communication with the flow channel through the plurality of voids.

22. The static mixer according to the claim 13, wherein the core is a helical member extending along the flow channel.

23. The static mixer according to claim 22, wherein the helical member includes a single blade wrapped helically about a central axis of the core.

24. The static mixer according to claim 22, wherein the helical member includes two opposed blades.

25. The static mixer according to claim 22, wherein the core has a skew in the range of 5-degrees to 75-degrees with respect to the transverse axis of the static mixer.

26. The static mixer according to claim 22, wherein the core has a pitch in the range of 5 millimeters to 25 millimeters.

27. The static mixer according to claim 22, wherein the core has a rake in the range of 5-degrees to 75-degrees with respect to the longitudinal axis of the static mixer.

28. The static mixer according to claim 12, wherein the core is a baffle member including a first blade and second blade, the first blade and the second blade angled with respect to each other in a range of 20 degree to 120 degrees to define a flow gap therebetween.

29. The static mixer according to claim 12, wherein the core is a grate member including a plurality of bars, each bar angled with respect to an adjacent bar in a range of 20 degrees to 120 degrees to define a flow gap therebetween.

30. A method of mixing biopharmaceutical compositions, the method comprising:
inserting a static mixer into a coupler; and
flowing a first fluid and a second fluid through the static mixer such that the first fluid and the second fluid are mixed together while the shear stress experienced by the first fluid and the second fluid during mixing remains below a predetermined shear stress.

31. The method according to claim 30, wherein inserting includes fixing the static mixer to the coupler.

32. The method according to claim 30, wherein inserting includes inserting another static mixer into the coupler.

33. A method of manufacturing a static mixer for mixing biopharmaceutical compositions, the method comprising:
simulating flow of a first fluid and a second fluid through a coupler including a static mixer;
determining a topology of the static mixer to mix the first fluid and the second fluid while limiting the shear stress for the first fluid and the second fluid below a predetermined shear stress; and
forming, by additive manufacturing, the static mixer with the determined topology.

34. A static mixer for use with biopharmaceutical compositions, the static mixer comprising:
a core having a first end and second end opposite the first end, the core defining a first set of flow channels and second set of flow channels, the first set of flow channels extending between the first end and the second end along a longitudinal axis of the core, the second set of flow channels extending transverse to the longitudinal axis of the core, the core configured to mix a first fluid and a second fluid together as the first fluid and the second fluid flow through the first set of flow channels and the second set of flow channels, the first fluid or the second fluid being a biopharmaceutical composition.

35. The static mixer according to claim 34, wherein the core defines a third set of flow channels, the third set of flow channels extending transverse to the longitudinal axis of the core.

36. The static mixer according to claim 35, wherein the second set of flow channels and the third set of flow channels extend transverse to the longitudinal axis of the core perpendicular with respect to each other.

37. The static mixer according to claim 36, wherein the first set of flow channels, the second set of flow channels, and the third set of flow channels intersect each other such that the core is formed as a lattice structure.

38. The static mixer according to claim 34, wherein the first end has a first diameter and the second end has a second diameter, the core having a taper along the longitudinal axis such that the first diameter is smaller than the second diameter.

39. The static mixer according to claim 34, wherein the first set of flow channels and the second set of flow channels are defined to have a wavy flow path.

40. The static mixer according to claim 34, wherein the static mixer is of monolithic construction.
